(19) United States
(12) Patent Application Publication
(10) Pub. No.: US 2022/0415160 A1
(43) Pub. Date: Dec. 29, 2022

(54) SHOCK DETECTION DEVICE, SYSTEM AND METHOD

(71) Applicant: Essence Security International (E.S.I.) Ltd, Herzeliya Pituach (IL)

(72) Inventors: Haim AMIR, Ramat Hasharon (IL); Ohad AMIR, Herzlia (IL)

(21) Appl. No.: 17/771,645

(22) PCT Filed: Oct. 23, 2020
(86) PCT No.: PCT/IL2020/051112

§ 371 Date: Apr. 25, 2022

(30) Foreign Application Priority Data
Oct. 25, 2019 (GB) 1915489.7

(51) Int. Cl. G08B 29/18; G08B 29/04

(52) U.S. Cl. CPC G08B 29/185; G08B 29/04

(57) ABSTRACT

A shock detector device (110) for premises security is described. The shock detector device (110) comprises a shock detector sensor (112) configured to sense physical motion and to output an electrical signal in response to the physical motion. Processing circuitry (114) is configured to process the electrical signal by: obtaining an indication that a shock event has occurred if a value for at least one parameter of the electrical signal is determined to exceed a threshold value; and processing instructions for adjusting at least one detection parameter of the shock detector device (110) in response to a determination that the shock event is a false alarm event, wherein the adjusting of the at least one detection parameter results in a decrease of a sensitivity of shock detection by the shock detector device (110).

### TECHNICAL FIELD

The present invention relates to a shock detection device, system and method for premises security.

### BACKGROUND

Shock detectors may be used at openable and/or closable entry points of a building, for example doors and/or windows. Shock detectors may be used to detect unexpected activity at the entry point that could be indicative of a threat event at the entry point. A threat event may include, for example, a break-in or attempted break-in. The shock detectors may be based on, for example, accelerometers, piezoelectric sensors or other vibration sensors.

A shock detector sensor may be placed in any suitable location on or near an entry point. For example, a sensor may be placed on the openable part of the door or window, or on a frame against which the openable part is normally closed.

Alarm systems may receive signals from shock detectors to trigger an alarm upon a detected shock-based threat event. The detection of the event may be based on defined detection sensitivity to a measured shock characteristic. For example, the detection of the event may be based on a peak or peak-to-peak signal, or on another characteristic that is representative of a transient vibration.

Measured shocks may be compared to a shock threshold, where measured shocks greater than the threshold result in a shock detection. A more sensitive shock detector may have a lower shock threshold. Conversely, a less sensitive shock detector may be produced by using a higher shock threshold.

The most suitable sensitivity for a given sensor may depend on the environment and surface upon which it is installed. An ideal setting for the sensor may not be known or determinable at the time of installation and/or may change after installation.

It is an aim of the invention to at least ameliorate one or more shortcomings of the prior art such as but not limited to any shortcomings disclosed herein, and/or to provide a useful alternative.

### SUMMARY

In a first aspect of the present invention there is provided a shock detector device for premises security. The shock detector device comprises a shock detector sensor configured to sense physical motion and to output an electrical signal in response to the physical motion; and processing circuitry configured to process the electrical signal by: obtaining an indication that a shock event has occurred if a value for at least one parameter of the electrical signal is determined to exceed a threshold value; and processing instructions for adjusting at least one detection parameter of the shock detector device in response to a determination that the shock event is a false alarm event, wherein the adjusting of the at least one detection parameter results in a decrease of a sensitivity of shock detection by the shock detector device.

If a sensor is too sensitive, an excessive number of false alarms may occur. For example, false alarms may occur due to wind or thunder or other vibration causing events that are not a security threat. Such stimuli may therefore generally be considered as noise. A determination that there has been a false alarm associated with a shock event, may be assumed to have been caused by a detection resulting from such noise. On the other hand, if the sensor is not sensitive enough, there may not be detection of stimuli that are generally associated with real threats, like breaking of a window or drilling through a door, for example. A determination that there has been a true alarm associated with a shock event, may be assumed to have been caused by a detection resulting from such stimuli that are generally associated with real threats.

As used herein the term “false alarm event” may be any event determined to have been caused by a non-security threat and may therefore be assumed to be have been caused by a detection resulting noise, i.e. a false detection by the shock detector. Similarly, a “true alarm event” may be any event determined to have been caused by a security threat, and therefore by a stimulus that can result in such a threat. A true alarm event may therefore alternatively be termed as a true detection by the shock detector.

A sensitivity of the shock detector device may be changed to adapt to its situation. As described above, the most suitable sensitivity for a given sensor may depend on, for example, the environment and surface upon which it is installed. By adjusting at least one detection parameter, the shock detector device may be adapted to its environment and/or surface. The sensitivity of the shock detector device may be adapted to its operational conditions in a dynamic and on-going manner.

A determination of whether the shock event is a false alarm event or a true alarm event may be received wirelessly from at least one further device. The instructions for adjusting the at least one detection parameter may be received wirelessly from the at least one further device. The processing circuitry may be further configured to communicate data representing the shock event to the at least one further device.

The processing circuitry may be further configured to communicate data representing the electrical signal to the at least one further device. The processing circuitry may be configured to receive the indication that a shock event has occurred from the at least one further device.

The processing circuitry may be configured to process the electrical signal to obtain the indication that a shock event has occurred. The processing circuitry may be configured to determine whether the least one parameter of the electrical signal exceeds a threshold value.

The determination of whether the shock event is a false alarm event or a true alarm event may be performed by processing circuitry of the shock detector device. The instructions for adjusting the at least one detection parameter may be provided by processing circuitry of the shock detector device.

In any case, the shock detector may conclude that the shock event corresponds to a false alarm event or a true alarm event if it received a notification from a further device that the event was a false alarm event or a true alarm event, respectively. Additionally or alternatively, the shock detector may conclude that the shock event corresponds to a false alarm event if it does not receive a notification that the event was a true alarm event; and/or may conclude that the shock event corresponds to a true alarm event if it does not receive a notification that the event was a false alarm event. For example, the shock detection device may, in response to the shock event, wirelessly transmit a notification of the event to the further device; and await a response from the further device within a defined time window, such as within a predefined time window of transmitting the notification of the event to the further device.

The detection parameter may be the threshold value.

The detection parameter may comprise one or more threshold values.

The detection parameter may comprise a parameter of the shock detector sensor. The parameter of the shock detector sensor may be a physical parameter. The detection parameter may comprise an amplification parameter. Adjusting the amplification parameter may adjust a degree of amplification of the electrical signal. A sensitivity of detection may be decreased by decreasing a degree of amplification while keeping the threshold value unchanged. By decreasing the degree of amplification, a larger physical motion may be required to cause the threshold value to be exceeded.

If a number of false alarm events and/or true alarm events occurring within a monitoring window, R, is below a threshold number, the processing circuitry may be configured to process instructions for a further adjustment of the at least one detection parameter. The further adjustment may result in an increase of a sensitivity of shock detection by the shock detector device.

The instructions for the further adjustment may be received from the at least one further device. The further device may be configured to monitor false alarm events and/or true alarm events occurring within the monitoring window, R. The monitoring window, R, may be a time period having a predetermined duration. The threshold number may be a predetermined number. The threshold number may be selected by a user.

The processing circuitry of the shock detector device may be further configured to monitor false alarm events and/or true alarm events occurring within the monitoring window, R. The instructions for the further adjustment of the at least one detection parameter may be provided by the processing circuitry of the shock detector device.

The processing circuitry may be further configured to obtain an indication that a further shock event has occurred. The processing circuitry may be further configured to process instructions for further adjusting the at least one detection parameter only if the further shock event occurred outside an exclusion window, T, following the decrease in sensitivity. The instructions for further adjusting the at least one detection parameter may be received wirelessly from at least one further device. A length of the exclusion window, T, may be dependent on a length of time since a preceding decrease in sensitivity. The instructions may be in response to the determination of a predetermined number of false alarm events within a collection period, S.

The processing circuitry may be further configured to obtain a determination of whether the further shock event is a false alarm event or true alarm event. If the further shock event is a false alarm event, the processing circuitry may be further configured to determine whether the further shock event occurred within an exclusion window, T, following the decrease in sensitivity. The processing circuitry may be further configured to process instructions for further adjusting the at least one detection parameter only if the further shock event occurred outside the exclusion window.

The exclusion window, T, may be a time period having a predetermined duration.

The processing circuitry may be further configured to change a length of the exclusion window, T, in dependence on a length of time since a preceding decrease in sensitivity.

The instructions may be processed in response to the determination that a predetermined number of false alarm events have occurred within a collection period, S. The predetermined number of false alarm events may be one. The predetermined number of false alarm events may be, for example, two, three, four, or five.

The shock detector device may have a predetermined maximum sensitivity of shock detection. The shock detector device may have a predetermined minimum sensitivity of shock detection. The adjusting of the at least one detection parameter may be restricted by the maximum sensitivity. The adjusting of the at least one detection parameter may be restricted by the minimum sensitivity.

In a second aspect of the invention, which may be provided independently, there is provided a system for premises security. The system comprises a shock detector sensor of a shock detector device, the shock detector sensor configured to sense physical motion and to output an electrical signal in response to the physical motion, wherein the shock detector device is configured for communicating with a control panel; and one or more processors configured to execute the functions of: (a) indicating that a shock event has occurred if a value for the at least one parameter of the electrical signal is determined to exceed a threshold value; (b) determining whether the shock event is a false alarm event or true alarm event; and (c) generating instructions for adjusting at least one detection parameter of the shock detector device in response to the determination of at least one false alarm event, wherein the adjusting of the at least one detection parameter results in a decrease of a sensitivity of shock detection by the shock detector device.

The one or more processors may comprise a plurality of processors. A first one or more of the plurality of processors may be located in the shock detector device. A second one or more of the plurality of processors may be located in the control panel.

The first one or more of the processors may be configured to execute function (a). The second one or more of the processors may be configured to execute at least one of functions (b) and (c).

The system may comprise the shock detector device according to the first aspect of the invention. The system may further comprise the control panel. The system may further comprise a server. The system may further comprise a monitoring system. The control panel may be configured to communicate with the server. The control panel may be configured to communicate with the monitoring system.

A third one or more of the processors may be located in the server and/or monitoring system. The third one or more of the processors may be configured to execute at least one of functions (a), (b) and (c).

The system may further comprise at least one further sensor. The determination of the false alarm event may be in dependence on data representative of an output of the at least one further sensor. Any method for determining a false alarm may be employed, including known methods.

For example, a control panel may receive an input from the shock sensor and an input from a motion sensor such as a passive infrared detector. If the shock sensor is located at a door or window to an environment and a motion sensor is located inside the environment, one would expect that if there were an entry via the door/window, motion in the environment would be detected shortly, thereafter. If no motion is detected in the environment within a predefined time after the door/window sensor detected a shock, it may be determined by the control panel that the event detected by the door/window sensor was a false alarm event. Additionally, or alternatively, if such motion was detected within the predefined time, it may be determined by the control panel that the event was a true alarm event.

In some embodiments, the determination of the false alarm event may be based on input received from an operator. For example, an operator may monitor an output from a further sensor (e.g. camera) to determine whether an intruder isn't or is present and therefore whether the alarm event is a false alarm event or a true alarm event, respectively. The shock sensor may then receive a true or false alarm notification, either directly from the monitoring station at which the operator is stationed or via one or more intermediate devices, e.g. control panel and/or sever.

Determinations of when there has been a true alarm event (true detection) or a false alarm event (false detection) may be performed in any number of ways, and at any stage. For example, the determination that a false alarm has occurred may result in the alarm system not sounding an alarm and/or not notifying a monitoring station of the event. This may occur for example, if a control panel that receives a notification of the shock event detection from the shock detector determines that the shock event was a false alarm. Thus, the alarm system may never even enter its alarm mode. In other embodiments, the determination of whether there has been a true or false alarm may occur after the alarm system enters an alarm mode. For example, a monitoring station may be notified of the event, potentially also after an alarm has been sounded. Such a scenario may occur for example, if true/false classification of the detected event is performed by a person at the monitoring station.

In a third aspect of the invention, which may be provided independently, there is provided method of adjusting a sensitivity of shock detection for premises security. The method comprises: sensing, by a shock detector sensor, physical motion; outputting, by the shock detector sensor, an electrical signal in response to the physical motion; obtaining, by at least one processor, an indication that a shock event has occurred if a value for at least one parameter of the electrical signal is determined to exceed a threshold value; obtaining, by the at least one processor, a determination of whether the shock event is a false alarm event or true alarm event; and processing, by the at least one processor, instructions for adjusting at least one detection parameter of the shock detector device in response to the determination of at least one false alarm event, wherein the adjusting of the at least one detection parameter results in a decrease of a sensitivity of shock detection by the shock detector device.

In a fourth aspect of the invention, which may be provided independently, there is provided a computer-readable medium comprising instructions which, when executed by a computer, cause the computer to perform the steps of: receiving an electrical signal; obtaining an indication that a shock event has occurred if a value for at least one parameter of the electrical signal is determined to exceed a threshold value; obtaining a determination of whether the shock event is a false alarm event or true alarm event; and processing instructions for adjusting at least one detection parameter of a shock detector device in response to the determination of at least one false alarm event, wherein the adjusting of the at least one detection parameter results in a decrease of a sensitivity of shock detection by the shock detector device.

Features in one aspect may be applied as features in any other aspect, in any appropriate combination. For example, method features may be provided as device features or vice versa.

### BRIEF DESCRIPTION OF THE SEVERAL VIEWS OF THE DRAWINGS

Embodiments will now be described by way of example only, and with reference to the accompanying drawings, of which:

FIG. 1 is a schematic illustration of a system for premises security in accordance with an embodiment;

FIG. 2 is a flow chart illustrating in overview a method of an embodiment;

FIG. 3 is a flow chart illustrating in overview a method of an embodiment;

FIG. 4 is a schematic illustration of a sensitivity adjustment in accordance with an embodiment;

FIG. 5 is a schematic illustration of sensitivity adjustments in accordance with an embodiment;

FIG. 6 is a schematic illustration of sensitivity adjustments in accordance with an embodiment;

FIG. 7 is a schematic illustration of a sensitivity adjustment in accordance with an embodiment;

FIG. 8 is a schematic illustration of a sensitivity adjustment in accordance with an embodiment; and

FIG. 9 is a flow chart illustrating in overview a method of an embodiment.

### DETAILED DESCRIPTION

As used herein, except where the context requires otherwise, the terms “comprises”, “includes”, “has”, and grammatical variants of these terms, are not intended to be exhaustive. They are intended to allow for the possibility of further additives, components, integers or steps.

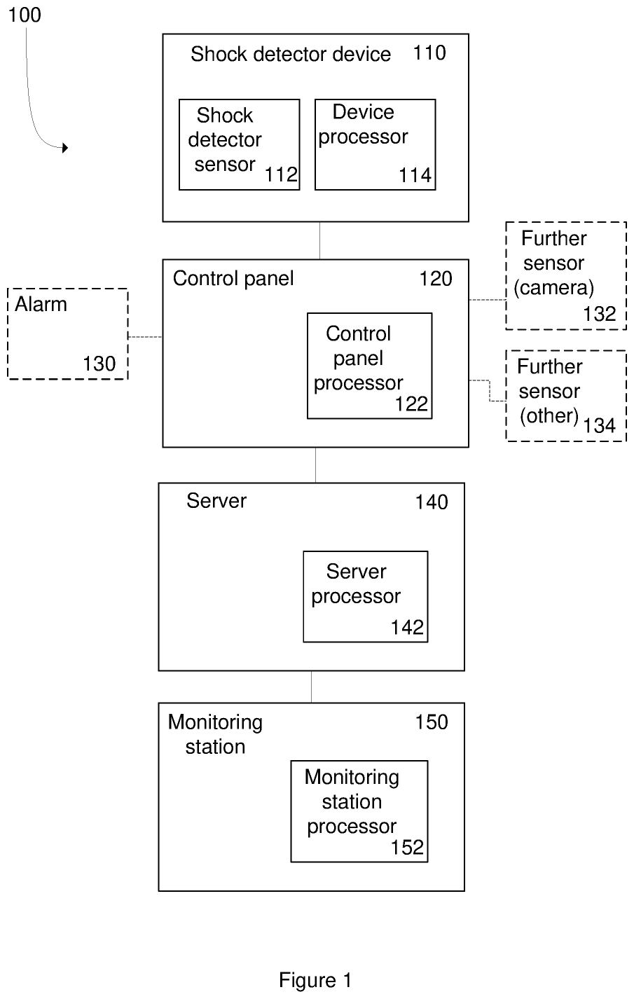

FIG. 1 is a schematic illustration of a system 100 for premises security in accordance with an embodiment.

The system 100 comprises a shock detector device 110, control panel 120, alarm 130, further sensors 132 and 134, server 140 and monitoring station 150.

The shock detector device 110 comprises a shock detector sensor 112 and a device processor 114. The shock detector sensor 112 is configured to sense physical motion. In the present embodiment, the physical motion comprises vibration. The shock detector sensor 112 may comprise, for example, an accelerometer and/or a piezoelectric sensor. The device processor 114 comprises processing circuitry configured to process electrical signals from the shock detector sensor 112. In other embodiments, part of the processing circuitry is in the shock detector sensor 112, and another part of the processing circuitry is in the device processor 114. The shock detector device 110 is configured to communicate wirelessly with the control panel 120.

The device processor 114 may comprise one or more processing chips. The device processor 114 may comprise one or more processing devices, such as microprocessors, microcontrollers, ASIC chips, FPGA chips or the like. A computer-readable medium (not shown) may store instructions to be performed by the device processor 114. The computer-readable medium may be a memory, which may be a single memory device or a plurality of memory devices. The memory may be located within the shock detector device 110 and/or outside the shock detector device 110. For example, the memory may be on a server and instructions to operate the device processor 114 may be downloaded from the server. Optionally, the server functions may be provided by a plurality of distributed computing devices, so that the instructions may be distributed amongst a plurality of memories on the respective computing devices. The computer-readable medium may comprise, for example, a system memory (for example, a ROM for a Bios), volatile memory (for example, a random access memory such as one or more DRAM modules), and/or non-volatile memory (for example, Flash memory or another EEPROM device).

The control panel 120 comprises a control panel processor 122. The control panel 120 is configured to communicate wirelessly with the shock detector device 110, alarm 130 and further sensors 132, 134. The control panel 120 is also configured to communicate wirelessly with the server 140. The control panel processor 122 may comprise one or more processing devices. Instructions to operate the control panel processor 122 may be stored on a computer-readable medium, which may be a memory. The processor and/or the computer-readable medium associated with the control panel may be provided by the same kind of processor and/or computer-readable medium as described above in relation to device 110.

The alarm 130 is configured to receive signals from the control panel 120. In response to signals from the control panel 120, the alarm 130 is configured to operate acoustic and/or visual transducers to issue an audible or visible alarm signal. The acoustic and/or visual transducers are not shown in FIG. 1.

In the embodiment of FIG. 1, one of the further sensors 132 comprises a camera. The other of the further sensors 134 may comprise any suitable sensor, for example a motion sensor. The further sensors 132, 134 are configured to send further sensor data wirelessly to the control panel 120.

A combination of the control panel 120, one or more shock detector devices 110, and optionally other peripheral devices 132, 134 may be referred to as an alarm system.

The server 140 may provide a back-end servicing system for the alarm system. The server 140 may be remote from the alarm system. The server 140 comprises a server processor 142. The server 140 is configured to communicate wirelessly with the control panel 120 and the monitoring station 150.

The monitoring station 150 comprises a monitoring station processor 142. The monitoring station 150 is configured to communicate wirelessly with the server 140. The monitoring station 150 may be remote from the alarm system and/or remote from the server 140. For example, the monitoring system 150 may be a central monitoring system for monitoring multiple alarm systems at multiple premises.

The monitoring station 150 may comprise a computer and/or a mobile device, for example a laptop, tablet or mobile phone. The monitoring station 150 may be monitored by a person. The monitoring station 150 may be configured to alert personnel if an alarm is triggered.

In some embodiments, the system 100 does not include a server 140 and/or monitoring station 150. In some embodiments, the system 100 does not include the alarm 130. The control panel may have a local alarm 130, or may control a local alarm 130. In some embodiments, the system 100 does not include further sensors 132, 134.

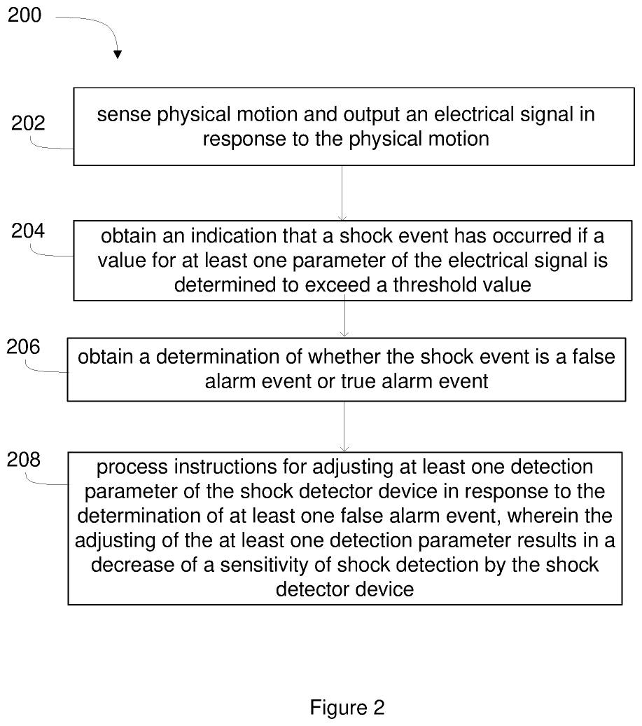

In use, the shock detector device 110 is positioned at or near an entry point. The entry point may be a door or window of a premises to be secured, for example a building to be secured. FIG. 2 shows a flow chart 200 illustrating in overview a method of an embodiment performed by the system of FIG. 1.

At stage 202, shock detector sensor 112 senses physical motion and outputs an electrical signal in response to the physical motion. At stage 204, an indication that a shock event has occurred is obtained if a value for at least one parameter of the electrical signal is determined to exceed a threshold value. At stage 206, a determination of whether the shock event is a false alarm event or a true alarm event is obtained. At stage 208, in response to the determination of at least one false alarm event, instructions to adjust at least one detection parameter of the shock detector device are processed. The adjusting of the at least one detection parameter results in a decrease of a sensitivity of shock detection by the shock detector device 110.

In some embodiments, the adjustment of the detection parameter is restricted by a maximum value and/or minimum value for the detection parameter, which may correspond to a maximum and/or minimum sensitivity.

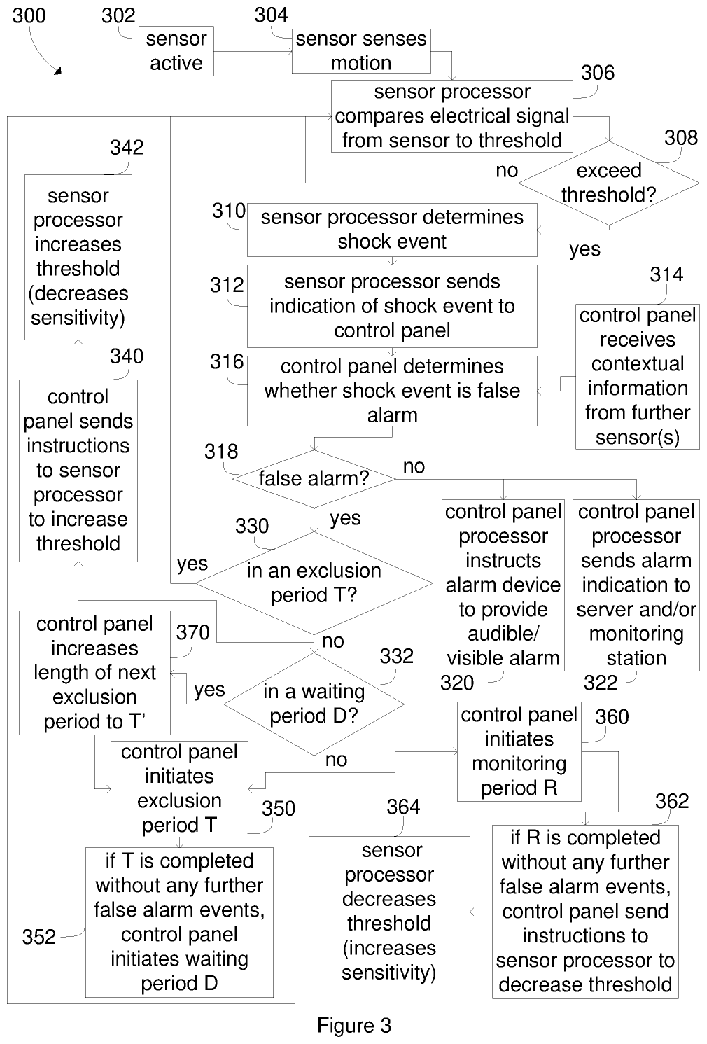

FIG. 3 shows a more detailed flow chart 300 which expands on the method outlined above with reference to FIG. 2.

At stage 302, the shock detector sensor 112 is active to sense motion. In the present embodiment, the shock detector sensor comprises an accelerometer and/or a piezoelectric sensor. More specifically, in some embodiments, the shock detector comprises at least an accelerometer.

At stage 304, the shock detector sensor 112 senses motion. The shock detector sensor 112 outputs an electrical signal which is representative of the motion sensed by the shock detector sensor 112. In the embodiment of FIG. 3, the electrical signal is representative of (for example, correlated with) an energy. In other embodiments, the electrical signal may be representative of any suitable physical parameter.

At stage 306, the device processor 114 compares at least one parameter of the electrical signal from the shock detector sensor 112 to at least one threshold value.

In the present embodiment, the device processor 114 compares a first parameter of the electrical signal to a value for a first threshold. The device processor 114 may additionally compare a second parameter of the electrical signal to a value for a second threshold. In some embodiments, the device processor may alternatively, rather than additionally, compare the second parameter of the electrical signal to the value for the second threshold.

A value for the first parameter may be obtained by the device processor 114 by integrating the output of the sensor 112 over a relatively short time window that commences at the beginning of a transient signal. For example, the time window may be a third of a second. The output that is integrated over the relatively short time window may be referred to as a first integrated output. The device processor 114 compares the first integrated output to the value for the first threshold.

A value for the second parameter may be obtained by the device processor 114 by integrating the output of the sensor 112 over a longer period of time, for example 20 seconds, to capture lower levels of vibration that happen over a sustained period of time or to capture repetitive low-level shocks. The output that is integrated over the longer time window may be referred to as a second integrated output. The device processor 114 compares the second integrated output to the value for the second threshold.

At stage 308, the device processor 114 determines whether the first integrated output has exceeded the first threshold value. The device processor 114 may also, or alternatively, determine whether the second integrated output has exceeded the second threshold value.

If neither threshold value is exceeded, the flow chart returns to stage 306 to perform a further comparison of an electrical signal with the threshold values, for example at a later time.

If the first integrated output exceeds the first threshold value and/or the second integrated output exceeds the second threshold value, the flow chart proceeds to stage 310. At stage 310, the sensor processor 114 determines that a shock event has occurred.

In other embodiments, detection of a shock event may be based on any measured shock characteristics, for example any suitable peak or peak-to-peak signal, or other characteristic that is representative of a transient vibration.

In the present embodiment, the device processor 114 also determines a type of shock event that has occurred. For example, if the first integrated output exceeds the first threshold value, the device processor 114 determines that a shock event of a first type has occurred. The first type of shock event may be called a gross shock. A gross shock may be a single shock event having energy above the first threshold value. If the second integrated output exceeds the second threshold value, the device processor 114 determines that a shock event of a second, different type has occurred.

The first and second integrated outputs provide first and second parameters for determining whether a shock has occurred. The first and second parameters may be used to detect different types of shocks. For example, the first parameter may capture a window breaking, whereas the second parameter may capture a person drilling through a door.

At stage 312, the device processor 114 sends an indication of the shock event to the control panel processor 122. The indication of the shock event may comprise a wireless signal comprising data that is representative of the shock event. The indication of the shock event may optionally comprise data representing the type of shock event that has occurred, the duration of the shock event, the intensity of the shock event, and/or any other suitable parameter relating to the shock event.

At stage 314 of the present embodiment, the control panel processor 122 receives contextual information from the further sensors 132, 134. In the embodiment of FIG. 3, the contextual information comprises visual information from the camera 132 and motion information from the further sensor 134. In other embodiments, any suitable contextual information may be obtained from one or more further sensors and/or from at least one further data source. For example, visual information and/or motion detection may be used to identify whether a person was (or may have been) present that could have caused the shock. In further embodiments, the control panel processor 122 may not receive contextual information from any further sensor. In such embodiments, stage 314 may be omitted.

At stage 316 of the present embodiment, the control panel processor 122 uses the indication of the shock event from stage 312 and the contextual information from stage 314 to determine whether the shock event is a false alarm event or a true alarm event. A false alarm event may be an event that is not related to a threat to security, for example an event that is caused by weather or by an authorised access to the premises. A true alarm event may be an event that is related to a threat to security, for example an attempted break-in. In other embodiments, the control panel processor 122 may determine whether the shock event is a false alarm event or a true alarm event using any suitable method, which may not comprise using contextual information received from one or more sensors.

In the present embodiment, the control panel processor 122 determines automatically whether the shock event is a false alarm event or a true alarm event. In other embodiments, the determining of whether a shock event is a false alarm event or a true alarm event may be determined by a person.

The control panel processor 122 passes to the sensor processor 114 a determination of whether the shock event is a false alarm event or a true alarm event. The sensor processor 114 processes the determination. In other embodiments, the control panel processor 122 only sends a message to the sensor processor 114 if the shock event is a true alarm event. If no such message is received, the sensor processor 114 determines that the shock event is a false alarm event. In further embodiments, the control panel processor 122 only sends a message to the sensor processor 114 if the shock alarm is a false alarm event. If no such message is received, the sensor processor 114 determines that the shock alarm is a true alarm event. In further embodiments, no indication is sent to the sensor processor 114 of whether the shock alarm is a true event or a false alarm event.

Stage 318, 330 and 332 are decision stages. At stage 318, if the shock alarm was determined to be a true alarm event, the method proceeds to stage 320 and 322. If the shock alarm was determined to be a false alarm event, the method proceeds to stage 330.

Consideration is made for the case of a true alarm event, in which the method proceeds to stages 320 and 322. Stages 320 and 322 may be performed simultaneously or in any order.

At stage 320, the control panel processor 122 sends an instruction to the alarm 130 to produce an audible and/or visible alarm. The alarm 130 operates at least one transducer to provide an audible and/or visible alarm signal. For example, an audible and/or visible alarm signal may be provided in the premises that is being protected by the system 100.

At stage 322, the control panel processor 122 sends data representative of an alarm indication to the server 140 and/or to the monitoring station 150. The server 140 may receive the data representative of an alarm indication and pass the data on to the monitoring station 150. By providing data representative of the alarm indication to the monitoring station 150, the system may alert a person to the alarm indication, for example a security guard or building manager.

Consideration is made for the case in which the shock event is a false alarm event. The method proceeds from stage 318 to stage 330. At stage 330, the control panel processor 122 determines whether an exclusion period T is currently in effect. The control panel processor 122 is configured to disregard false alarm events that fall within the exclusion period T. If an exclusion period T is in effect, the control panel processor 122 does not instruct any change to any threshold value. The method returns to stage 306 to continue comparing the electrical signal to the threshold values.

If no exclusion period T is in effect, the method proceeds from stage 330 to stages 332 and 340. In the present embodiment, stages 332 and 340 occur simultaneously. In other embodiments, stages 332 and 340 may occur in any order.

At stage 340, the control panel processor 122 sends instructions to the device processor 114 to increase a threshold value for identifying (i.e. detecting) a shock event.

For simplicity, in the following discussion we refer generally to a shock event and to changing a threshold value. However, as described above, the device processor 114 of the present embodiment may determine two types of shock event, each having an associated threshold value. In practice, the control panel processor 122 may send instructions to the device processor 114 to increase the threshold value that is appropriate to the shock event. If the shock event is a gross shock event of the first type, the control panel processor 122 may send instructions to the device processor 114 to increase the first threshold value. If the shock event is a shock event of the second type, the control panel processor 122 may send instructions to the device processor 114 to increase the second threshold value. In other embodiments, both the first and second threshold are increased regardless of the type of detected shock event that led to the false alarm.

At stage 342, the device processor 114 processes the instructions received from the control panel processor 122. The device processor 114 increases the value for a or the threshold(s) in response to the instructions. Increasing the value for the threshold may be considered to decrease the sensitivity of the shock detector device 110 to shock. A more intense shock will be needed to trigger a shock event. In some embodiments, the device processor 114 does not increase the threshold value if the increase would cause the threshold value to exceed a maximum threshold value and/or cause the sensitivity to fall below a minimum sensitivity. A maximum and/or minimum sensitivity may be a defined default, for example a default set during manufacture, or may be configured by a technician at installation.

The decrease in sensitivity may be by a predetermined amount. The decrease in sensitivity may be a predefined percentage of a dynamic range between maximum and minimum sensitivity limits, for example by 20% of the dynamic range. An increase in threshold value may be by a percentage of a range between minimum and maximum threshold values.

In further embodiments, the control panel processor 122 may send instructions to change any suitable detection parameter, which may or may not be a threshold value. The change in detection parameter is such as to decrease the sensitivity of the shock detector device. For example, in one alternative embodiment, the detection parameter is an amplification parameter of the shock detector sensor 112. The amplification parameter is for a processing stage that is prior to the threshold comparator for detecting shock. The control panel processor 122 sends instructions to decrease the amplification parameter, thereby decreasing a degree of amplification of the shock detector sensor 112. If the threshold value is kept constant, the decreased amplification means that the threshold value is only exceeded by larger shocks, causing a decrease in sensitivity. Returning to the embodiment of FIG. 3, after stage 342, the method returns to stage 306.

The device processor 114 compares the electrical signal from the sensor to one or more threshold values. The threshold values include the threshold value that was increased at stage 342.

At stage 332, the control panel processor 122 determines whether a waiting period D is in effect. If no waiting period D is in effect, the method proceeds to stages 350 and 360. If a waiting period D is in effect, the method proceeds to stage 370 and then to stage 350.

We consider first the scenario in which no waiting period D is in effect and the method proceeds from stage 332 to stages 350 and 360.

At stage 350, the control panel processor 122 initiates an exclusion period T. The exclusion period T is a time period having a predetermined length. In some embodiments, a length of the exclusion period is dependent on a present sensitivity level, for example a present threshold value. The exclusion period T is a time during which the control panel processor 122 will not instruct any further decrease in sensitivity. An exclusion period is used so that multiple shock events occurring in quick succession do not trigger multiple decreases in sensitivity within a short time period.

In some circumstances, a potential intruder may try to tamper with the shock detector system by deliberately causing a number of false alarms to decrease sensitivity to make intrusion thereafter less detectable. The use of an exclusion period may reduce or minimise the effect of such tampering attempt. The exclusion period may provide a defined time window wherein, following a decrease in sensitivity in response to a processed false alarm, subsequent false alarms during the time window will not further decrease the sensitivity. For example, the exclusion period may be 24 hours.

If the exclusion period T ends without any further false alarm events having occurred, the method proceeds to stage 352. At stage 352, the control panel processor 122 initiates a waiting period D. The waiting period D is a time period of a predetermined length. In some embodiments, a length of the waiting period may be dependent on a current sensitivity level, for example a current threshold value. The length of the waiting period D may be different from the length of the exclusion period T. In some embodiments, a length of the waiting period D is a multiple of a length of the exclusion period T by a factor that is greater than 1. In some embodiments the multiple is an integer.

If a further false alarm event occurs within the waiting period D, the control panel processor 122 is configured to instruct a further decrease in sensitivity as described above in relation to stage 340, and to change the length of a subsequent exclusion period T′ as described below in relation to stage 370.

The exclusion period duration may be adapted to be lengthened in response to a plurality of sensitivity decreasing events. For example, if a second false alarm happened within a time period ending at a first predefined time after expiry of the exclusion period T, the length of the next exclusion period may be increased, for example by a factor of five. In the case of increasing to a 5-day (for example) exclusion period in response to a second decrease in sensitivity, there would be then be a five day period in which further false alarms that occur during that time would not cause further decreases in sensitivity.

In other embodiments, a length of the exclusion period T may be changed in any suitable manner. For example, a length of the exclusion period T may be based on a time since the last shock event, or the last false alarm event. A length of the exclusion period T may be based on an interval between shock events. The exclusion period may be extended to a greater degree if the interval between false alarm events is smaller. For example, if a further false alarm event occurs early in the waiting period D, the extension to the next exclusion period may be longer than if the further false alarm event occurred later in the waiting period D.

The exclusion period T and waiting period D may run in parallel with the comparing of the electrical signal to the threshold values at stage 306, and with any further shock event determination that occurs within a monitoring period.

Stage 360 is performed at the same time as stage 350. At stage 360, the control panel processor 122 initiates a monitoring period R. The monitoring period R is a time period having a predetermined length. In some embodiments, a length of the monitoring period is dependent on a current sensitivity level, for example a current threshold level. The length of the monitoring period R may be configurable. The monitoring period R may run in parallel with exclusion period T and/or waiting period D. In the present embodiment, the monitoring period R is longer than the combination of the exclusion period T and waiting period D. In some embodiments, the monitoring period R has the same length as the waiting period D, or the same length as a combination of the exclusion period T and waiting period D. In some embodiments, a length of the monitoring period R is a multiple of a length of the exclusion period T.

The monitoring period R also may run in parallel with the comparing of the electrical signal to the threshold values at stage 306, and with any further shock event determination that occurs within the monitoring period.

The control panel processor 122 monitors whether any further false alarm event occurs during the monitoring period R. If the monitoring period R is completed with no further false alarm event, the method proceeds to stage 362. At stage 362, the control panel processor 122 sends instructions to the device processor 114 to decrease a detection threshold value, thereby increasing the sensitivity of shock detection by the shock detector device 110. In the present embodiment, both threshold values are decreased if R is completed without any false alarm events. In other embodiments, only one of the threshold values may be decreased. In some embodiments, separate monitoring periods are used for the different types of shock events.

In some embodiments, the device processor 114 does not decrease the threshold value if the decrease would cause the threshold value to fall below a minimum threshold value and/or cause the sensitivity to exceed a maximum sensitivity.

At stage 364, the device processor 144 decreases the threshold value as instructed by the control panel processor 122. The method then returns to stage 306.

If a further false alarm event occurs within the monitoring period R, the method proceeds from stage 310 as described above, including restarting the monitoring period R at a further instance of stage 360.

In general, it may be desirable to keep a number of false alarm events relatively low. However, if no false alarm events are occurring at all, it may be the case that the detection is not sensitive enough. By using the monitoring period R, a sensitivity may be increased if no false events are occurring. The use of the monitoring period may maintain the shock detector system in a configuration that it will continue to detect shock events.

Now consider the outcome of stage 332 in which the control panel processor 122 has determined that a waiting period D is ongoing. The method proceeds from stage 332 to stage 370.

At stage 370, the control panel processor 122 increases a length of a next exclusion period T. The increased length of the next exclusion period may be denoted as T′.

The method then proceeds to stage 350 at which an exclusion period is initiated, the exclusion period having the increased length T′.

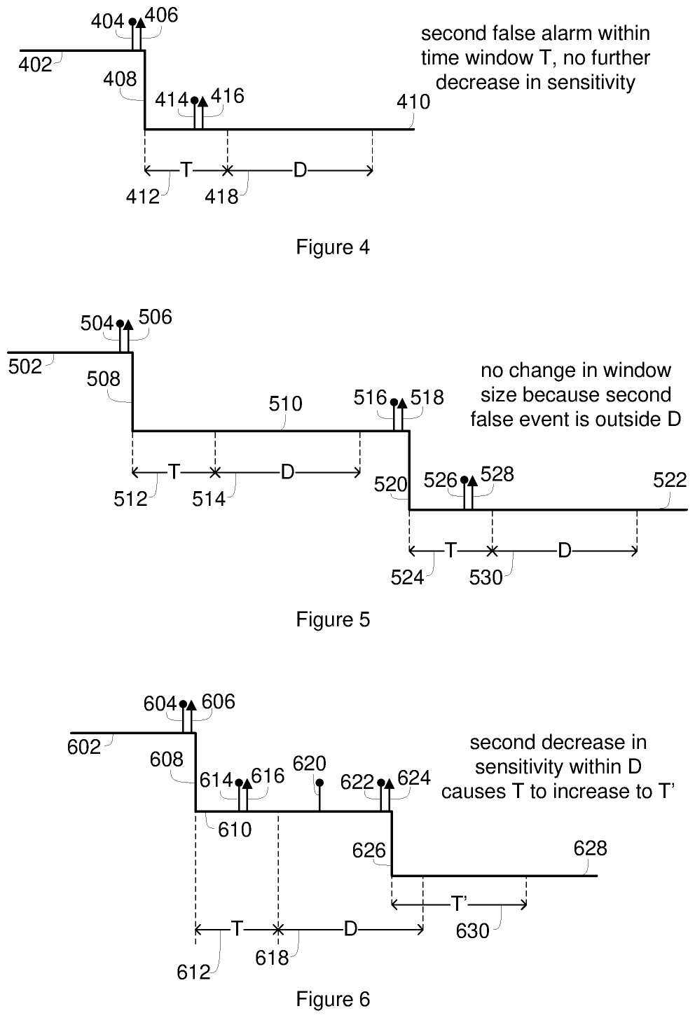

Exclusion periods, waiting periods and monitoring periods are discussed further below with reference to FIGS. 4 to 8. In each of FIGS. 4 to 8, time is represented from left to right. Sensitivity is represented from bottom to top, with low sensitivity at the bottom of the figure and high sensitivity at the top.

FIGS. 4 to 8 are described with reference to a single threshold for simplicity. However, the methods of FIGS. 4 to 8 may also be applied to multiple threshold values.

FIG. 4 shows an example of a shock detection process in accordance with the method of FIG. 3. At the start of FIG. 4, a sensitivity of detection is high, as shown by line 402. A first shock event is detected by the shock detection device 110 and is illustrated as a first graphical element 404. An arrow 406 represents a determination by the control panel processor 114 that the first shock event 404 is a false alarm event.

In response to the determination 406 that the first shock event 404 is a false alarm event, the control panel processor 122 issues an instruction to change the threshold value and thereby the sensitivity of detection. The device processor 114 increases the threshold value, providing a decrease in sensitivity. The decrease in sensitivity is shown as line 408. The new, lower sensitivity is shown as line 410.

In some circumstances, the decrease in sensitivity may reduce the number of future false alarm events. If a large number of false alarm events occur, it may be the case that the detection is too sensitive.

However, it may be undesirable to decrease the sensitivity repeatedly in response to false alarm events occurring within a short period of time. For example, false alarm events that occur in quick succession may all have the same cause.

Therefore, an exclusion period T, shown as 412, is used to exclude further false alarm events that occur soon after the decrease in sensitivity 408. The control panel processor 122 initiates the exclusion period 412 at the same time as instructing the decrease in sensitivity 408.

In FIG. 4, element 414 represents a second shock event that occurs within the exclusion period 412. Arrow 416 represents a determination that the second shock event is a false alarm event. Because the second shock event 414 occurs within the exclusion period 412, the control panel processor 122 does not instruct any further decrease in sensitivity in response to the second shock event 414.

At the end of the exclusion period 412, the control panel processor 122 initiates a waiting period D, shown as 418. In the example of FIG. 4, no further shock event occurs within the waiting period 418. The waiting period D is discussed below with reference to FIG. 6.

FIG. 5 shows a further example of shock detection using the method of FIG. 3. At the start of FIG. 5, a sensitivity of detection is high as shown by line 502. A first shock event is illustrated as element 504. An arrow 506 represents a determination by the control panel processor 114 that the first shock event 504 is a false alarm event.

In response to the determination that the first shock event 504 is a false alarm event, the control panel processor 122 issues an instruction to change the threshold value and therefore the sensitivity of detection. Line 508 represents the decrease in sensitivity. Line 510 represents the new, decreased sensitivity. The control panel processor 122 also initiates an exclusion period T, shown as 512.

At the end of the exclusion period 512, the control panel processor 122 initiates a waiting period D, shown as 514. In the example of FIG. 5, no further shock event occurs within the exclusion period 512 or waiting period 514.

After the exclusion period 512 and waiting period 514, a second shock event occurs. The second shock event is shown by element 516. Arrow 518 represents a determination that the second shock event 516 is a false alarm event.

The control panel processor 122 instructs a further decrease in sensitivity in response to the determination that the second shock event 516 is a false alarm event. The further decrease in sensitivity is shown as line 520. The further decreased sensitivity is shown as line 522.

At the same time as instructing the further decrease in sensitivity, the control panel processor 122 initiates a further exclusion period 524. Exclusion periods 512, 524 each have the same duration T.

A third shock event 526 occurs within the exclusion period 524 following the second decrease in sensitivity. Arrow 528 represents the determining that the third shock event 526 is a false alarm event. Since the third shock event 526 occurs within the exclusion period 524, no further decrease in sensitivity is instructed by the control panel processor 122 in response to the third shock event 526.

Once the exclusion period 524 is complete, the control panel processor 122 initiates a waiting period D, shown as 530. The length of waiting period 530 is the same as the length of waiting period 614.

FIG. 6 is a further example of shock detection using the method of FIG. 3. At the start of FIG. 6, a sensitivity of detection is high as shown by line 602. A first shock event is illustrated as a first element 604. An arrow 606 represents a determination by the control panel processor 114 that the first shock event 604 is a false alarm event.

In response to the determination that the first shock event is a false alarm event, the control panel processor 122 issues an instruction to change the threshold value and therefore the sensitivity of detection. Line 608 represents a decrease in sensitivity. Line 610 represents the new, decreased sensitivity. The control panel processor 122 initiates an exclusion period T, shown as 612, at the same time as instructing the decrease in sensitivity.

Element 614 represents a second shock event that occurs within the exclusion period 612. Arrow 616 represents a determination that the second shock event is a false alarm event. Because the second shock event 614 occurs within the exclusion period 612, the control panel processor 122 does not instruct any further decrease in sensitivity in response to the second shock event 614.

At the end of the exclusion period 612, the control panel processor 122 initiates a waiting period D, shown as 618.

A third shock event 620 occurs within the waiting period 618. There is no determination that the third shock event 620 is a false alarm event. It may therefore be assumed that the third shock event is a true alarm event. The control panel processor 114 does not trigger any change in sensitivity or change in any time period in response to the third shock event 620. An alarm (not shown) may be triggered in response to the third shock event 620.

A fourth shock event 622 occurs within the waiting period 618. Arrow 624 represents a determination that the fourth shock event 622 is a false alarm event. In response to the determination that the fourth shock event is a false alarm event, the control panel processor 122 issues an instruction to change the threshold value and therefore the sensitivity of detection. Line 626 represents a decrease in sensitivity. Line 628 represents the new, decreased sensitivity.

As the fourth shock event 622 occurred within the waiting period 618, the control panel processor 122 also increases the length of the next exclusion period from T to T′. Exclusion period T′, shown as 630, is initiated in response to the fourth shock event 622.

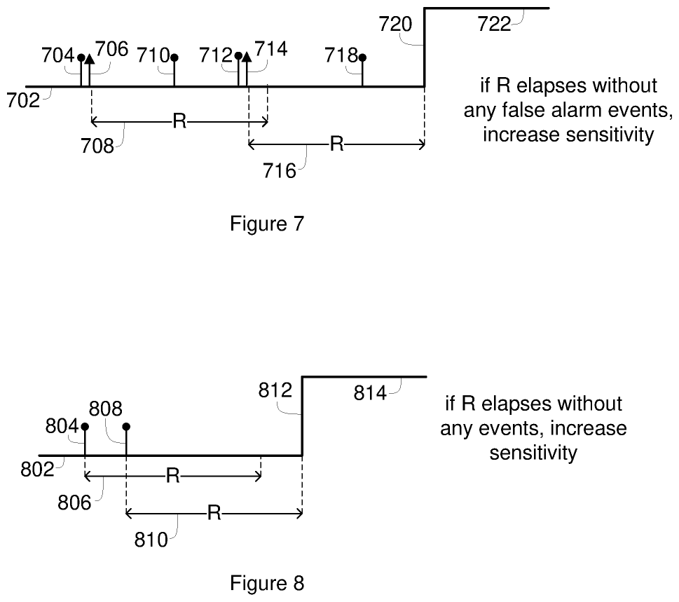

FIGS. 7 and 8 relate to the monitoring period R. For simplicity, FIGS. 4 to 6 did not show monitoring period R, and FIGS. 7 and 8 do not show exclusion period T and waiting period D. However, it may be expected that in many embodiments/circumstances the monitoring period R will run in parallel with the exclusion period T and waiting period D.

FIG. 7 is a further example of shock detection using the method of FIG. 3. At the start of FIG. 7, a sensitivity of detection is low as shown by line 702. For example, a sensitivity of detection may be at a minimum sensitivity. A first shock event is illustrated as a first element 704. An arrow 706 represents a determination by the control panel processor 114 that the first shock event 704 is a false alarm event.

In response to the determination that the first shock event 704 is a false alarm event, the control panel processor 122 initiates a monitoring period R, shown as 708 in FIG. 7. If there are no further false alarm events in a monitoring period, the control panel processor 122 will instruct the device processor 114 to decrease the threshold value, thereby increasing the sensitivity of detection. In this example, there is no decrease in the sensitivity of detection in response to the false alarm event either because the sensitivity of detection is already at a minimum sensitivity or because the false alarm occurred in the exclusion period (not shown).

In the example shown, a second shock event 710 occurs within monitoring period 708. The second shock alarm is a true alarm event. In the embodiment of FIG. 3, the control panel processor 122 does not take true alarm events into account when considering whether to change a sensitivity at the end of the monitoring period.

A third shock event 712 also occurs within monitoring period 708. An arrow 714 represents the third shock event 712 being determined to be a false alarm event.

Since a further shock event has occurred within the monitoring period 708, the monitoring period 708 has not elapsed without any further shock events.

The control panel processor 122 starts a second monitoring period R in response to the determining that the third shock event 712 is a false alarm event. The second monitoring period is shown as 716 in FIG. 7.

A fourth shock event 718 occurs within the second monitoring period 716. The fourth shock event 718 is a true alarm event. The control panel processor 122 does not take true alarm events into account when determining whether to increase sensitivity.

The second monitoring period 716 elapses without any further false alarm events. The control panel processor 122 instructs the device processor 114 to decrease a threshold value so that sensitivity is increased. The increase in sensitivity is shown as line 720. The new, higher sensitivity is shown as line 722.

In the embodiment of FIGS. 3 to 7, the control panel processor 122 does not take true alarm events into account when considering whether to change a sensitivity and/or a length of a time period. In other embodiments, the control panel processor 122 takes both true alarm events and false alarm events into account when determining whether to decrease sensitivity. In some embodiments, the control panel processor 122 takes both true alarm events and false alarm events into account when determining whether to increase sensitivity. In some embodiments, the control panel processor 122 takes both true alarm events and false alarm events into account when determining whether to change a time period, for example a length of an exclusion period.

FIG. 8 shows an embodiment is which the control panel processor 122 takes both false alarm events and true alarm events into account when considering whether to increase a sensitivity. If a monitoring period elapses without any shock events occurring, the control panel processor 122 instructs a decrease in threshold value, causing an increase in sensitivity.

At the start of FIG. 8, a sensitivity of detection is low as shown by line 802. The sensitivity of detection may be a minimum sensitivity. A first shock event is illustrated as a first element 804. The first shock event is a true alarm event. In the embodiment of FIG. 8, the control panel processor 122 initiates a monitoring period R, shown as 806, in response to the first shock event.

A second shock event occurs within the first monitoring period 806. The second shock event is also a true alarm event. The control panel processor 122 initiates a second monitoring period 810 in response to the second shock event.

No further shock events occur within the second monitoring period 810. The control panel processor 122 instructs the device processor 114 to decrease a threshold value so that sensitivity is increased. The increase in sensitivity is shown as line 812. The new, higher sensitivity is shown as line 814.

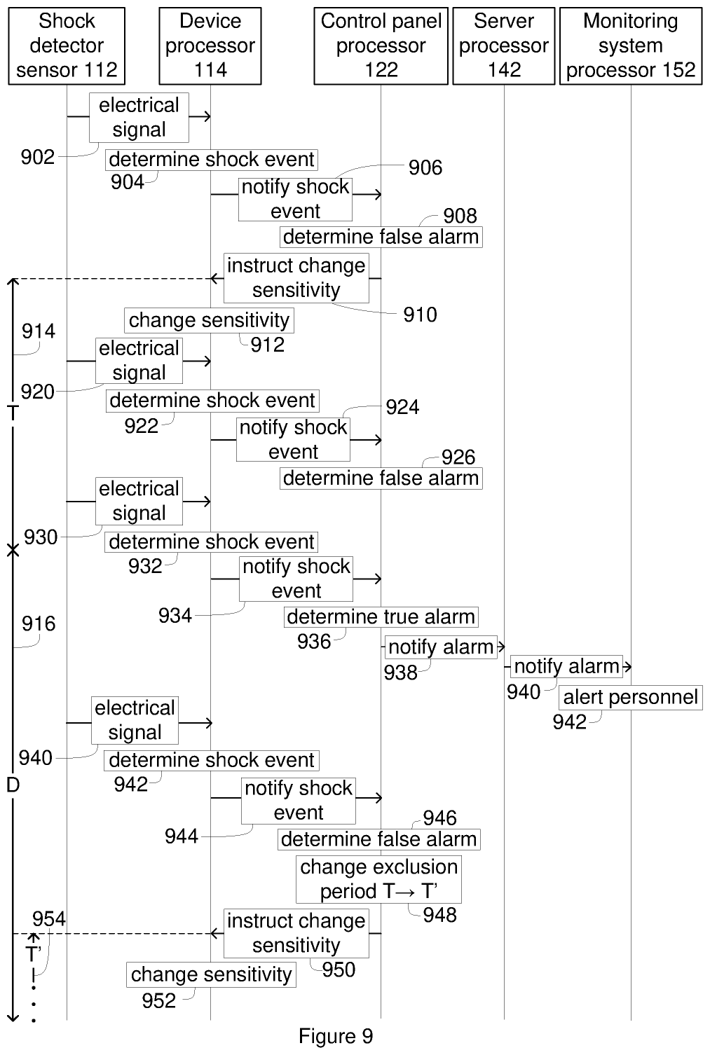

FIG. 9 shows examples of signals sent between the shock detector sensor 112, device processor 114, control panel processor 122, server processor 142 and monitoring system processor 152 in an example of a detection method performed in accordance with the method of FIG. 3.

An electrical signal 902 is sent from the shock detector sensor 112 to the device processor 904. At stage 904, the device processor 114 processes the electrical signal 902 and determines that a shock event has occurred.

The device processor 114 sends to the control panel processor a message 906 that notifies the control panel processor 122 that a shock event has occurred.

At stage 908, the control panel processor 112 determines that the shock event is a false alarm. The determination may be based at least partially on data received from one or more further sensors. The data received from the one or more further sensors is not shown in FIG. 9.

The control panel processor 122 sends to the device processor 114 a message 910 instructing the device processor 114 to change a sensitivity. In the present embodiment, the message 910 instructs the device processor 114 to increase a threshold value. In other embodiments, the message 910 may instruct the device processor 114 to change a value for any appropriate parameter.

At that same time as the message instructing the change in sensitivity, the control panel processor initiates an exclusion period T, shown as 914 on FIG. 9.

At stage 912, in response to the message 910, the device processor 114 increases the threshold value, thereby decreasing the sensitivity of detection.

The shock detector 112 sends an electrical signal 920 to the device processor 114. The electrical signal 920 is representative of sensor output at a later time than the electrical signal 902.

At stage 922, the device processor 114 determines that a shock event has occurred. The device processor 114 sends a message 924 to the control panel processor 122 to notify the control panel processor 122 of the shock event.

At stage 926, the control panel processor 122 determines that the shock event notified in message 924 is a false alarm event. The control panel processor 122 does not instruct any change in sensitivity since the time is still within the exclusion period 914.

The shock detector 112 sends an electrical signal 930 to the device processor 114. The electrical signal 930 is representative of sensor output at a later time than the electrical signal 920.

At stage 932, the device processor 114 determines that a shock event has occurred. The device processor 114 sends a message 934 to the control panel processor 122 to notify the control panel processor 122 of the shock event. At stage 936, the control panel processor 122 determines that the shock event notified in message 924 is a true alarm.

The control panel processor 122 sends a message 938 to the server processor 142. The message 930 notifies the server processor 142 of the alarm. The server processor 142 sends a message 940 to the monitoring system processor 152. The message 940 notifies the monitoring system processor 152 of the alarm. At stage 942, the monitoring system processor 152 alerts personnel in response to the alarm.

After exclusion period 914 has finished without any further false alarms, the control panel processor 122 initiates waiting period D, shown as 916.

At a time within waiting period D, the shock detector 112 sends an electrical signal 940 to the device processor 114. At stage 942, the device processor 114 determines that a shock event has occurred. The device processor 114 sends a message 944 to the control panel processor 122 to notify the control panel processor 122 of the shock event. At stage 946, the control panel processor 122 determines that the shock event notified in message 924 is a false alarm event.

At stage 948, the control panel processor 122 changes a length of a next exclusion period to a longer period T′.

The control panel processor 122 sends a message 950 to the device processor 114 instructing the device processor 114 to change a sensitivity. In this embodiment, the message instructs the device processor to increase a threshold value, thereby lowering the sensitivity.

At the same time as sending the message 950, the control panel processor 122 initiates the next exclusion period T′, shown as 954 on FIG. 9.

At stage 952, the device processor 114 increases the threshold value as instructed, thereby decreasing the sensitivity.

A method of dynamically adapting a sensitivity of shock detections is therefore provided. A shock detector device communicates shock detection events to an upstream device of a security system, for example a control panel and/or a remote monitoring station or server. A sensitivity of detection may be adjusted in a dependence on shock events detected, and whether they are false alarm events or true alarm events.

Adapting a sensitivity may allow a shock detector device to be adapted to an environment in which is installed. The sensitivity may be adjusted to avoid an excessive number of false events, while still having enough sensitivity for shock events to be detected.

In some embodiments described above, the control panel processor 122 may issue instructions to change a detection parameter in response to a single false alarm event. In other embodiments, the control panel processor 122 monitors false alarm events occurring within a collection period, S. The collection period, S, is a time period having a predetermined length. The control panel processor 122 issues instructions to change a detection parameter if a predetermined number of false alarm events are detected within the collection period. For example, the predetermined number may be one, two, three, four, or five.

In embodiments described above, the control panel processor 122 instructs an increase in sensitivity if no false alarm events, or no shock events, occur during the monitoring period. In other embodiments, the control panel processor 122 monitors a number of further false alarm events occurring during the monitoring period. If the number of false alarm events is below a threshold number, the control panel processor 122 instructs a change in at least one detection parameter, for example a decrease in at least one threshold value. For example, the threshold number may be one, two, three, four or five.

In embodiments described above, the device processor 114 determines the shock event and passes an indication of the shock event to the control panel processor 122. The control panel processor 122 determines whether the shock event is a false alarm event or a true alarm event. In other embodiments, the device processor 114 sends to the control panel processor 122 data that is representative of the electrical signal output by the shock detector sensor 112. The control panel processor 122 determines that a shock event has occurred.

In further embodiments, it is the device processor 114 that determines whether the shock event is a false alarm event or a true alarm event. In one embodiment, the device processor 114 determines that a shock event has occurred. The device processor 114 receives contextual information from the control panel processor 122. The device processor 114 determines whether the shock event is a false alarm event or a true alarm event based on the contextual information.

In other embodiments, any of the steps provided above may be performed by the device processor 114; by the control panel processor 122; or by any other processor, for example the server processor 142 or monitoring station processor 152. The steps may be divided across any number of processors in any suitable manner. A single step may be split across multiple processors, or multiple steps may be performed by a single processor. Data may be sent to and from any suitable processors.

It will be appreciated by the person skilled in the art that the term control panel does not literally require a panel but rather is a historical term of art for what in current times may more generally be referred to as a control hub. Thus, the term “control panel” may be used interchangeably with “control hub”.

Whilst the foregoing description has described exemplary embodiments, it will be understood by those skilled in the art that many variations of the embodiments can be made within the scope of the present invention as defined by the claims. Moreover, features of one or more embodiments may be mixed and matched with features of one or more other embodiments.

1. A shock detector device for premises security, the shock detector device comprising:
a shock detector sensor configured to sense physical motion and to output an electrical signal in response to the physical motion; and
processing circuitry configured to process the electrical signal by:
obtaining an indication that a shock event has occurred if a value for at least one parameter of the electrical signal is determined to exceed a threshold value; and
processing instructions for adjusting at least one detection parameter of the shock detector device in response to a determination that the shock event is a false alarm event, wherein the adjusting of the at least one detection parameter results in a decrease of a sensitivity of shock detection by the shock detector device, wherein the determination of whether the shock event is a false alarm event and/or the instructions for adjusting the at least one detection parameter are received wirelessly from at least one further device.

2. (canceled)

3. A shock detector device according to claim 2, wherein the processing circuitry is further configured to communicate data representing the electrical signal and/or data representing the shock event to the at least one further device.

4. A shock detector device according to claim 1, wherein the detection parameter is the threshold value.

5. A shock detector device according to claim 1, wherein:
if a number of false alarm events occurring within a monitoring window, R, is below a threshold number, the processing circuitry is configured to process instructions for a further adjustment of the at least one detection parameter, wherein the further adjustment results in an increase of a sensitivity of shock detection by the shock detector device.

6. A shock detector device according to claim 1, wherein:
a determination is made of whether the shock event is a true alarm event; and
if a number of true alarm events occurring within a monitoring window, R, is below a threshold number, the processing circuitry is configured to process instructions for a further adjustment of the at least one detection parameter, wherein the further adjustment results in an increase of a sensitivity of shock detection by the shock detector device.

7. A shock detector device according to claim 1, wherein the processing circuitry is further configured to:
obtain an indication that a further shock event has occurred; and
process instructions for further adjusting the at least one detection parameter only if the further shock event occurred outside an exclusion window, T, following the decrease in sensitivity.

8. A shock detector device according to claim 7, wherein a length of the exclusion window, T, is dependent on a length of time since a preceding decrease in sensitivity.

9. A shock detector device according to claim 1, wherein the instructions are in response to the determination of a predetermined number of false alarm events within a collection period, S.

10. A shock detector device according to claim 1, the shock detector device having a predetermined maximum and minimum sensitivity of shock detection, wherein the adjusting of the at least one detection parameter is restricted by the maximum and minimum sensitivity.

11. A system for premises security, the system comprising:
a shock detector sensor of a shock detector device, the shock detector sensor configured to sense physical motion and to output an electrical signal in response to the physical motion, wherein the shock detector device is configured for communicating with a control panel; and
one or more processors configured to execute the functions of:
a) indicating that a shock event has occurred if a value for the at least one parameter of the electrical signal is determined to exceed a threshold value;
b) determining whether the shock event is a false alarm event or true alarm event; and
c) generating instructions for adjusting at least one detection parameter of the shock detector device in response to the determination of at least one false alarm event, wherein the adjusting of the at least one detection parameter results in a decrease of a sensitivity of shock detection by the shock detector device.

12. A system according to claim 11, wherein the one or more processors comprises a plurality of processors, wherein a first one or more of the plurality of processors is located in the shock detector device and a second one or more of the plurality of processors is located in the control panel.

13. A system according to claim 12, wherein the first one or more of the processors is configured to execute function (a) and the second one or more of the processors is configured to execute at least one of functions (b) and (c).

14. A system according to claim 11, further comprising the control panel, and further comprising a server and/or a monitoring system, wherein the control panel is configured to communicate with the server and/or monitoring system.

15. A system according to claim 14, wherein a third one or more of the processors is located in the server and/or monitoring system, and is configured to execute at least one of functions (a), (b) and (c).

16. A system according to claim 11, further comprising at least one further sensor, wherein the determination of the false alarm event is in dependence on data representative of an output of the at least one further sensor.

17. A system according to claim 11, further wherein the determination of the false alarm event is based on input received from an operator.

18. A method of adjusting a sensitivity of shock detection for premises security, the method comprising:
sensing, by a shock detector sensor, physical motion;
outputting, by the shock detector sensor, an electrical signal in response to the physical motion;
obtaining, by a processor, an indication that a shock event has occurred if a value for at least one parameter of the electrical signal is determined to exceed a threshold value;
obtaining, by the processor, a determination of whether the shock event is a false alarm event or true alarm event; and
processing, by the processor, instructions for adjusting at least one detection parameter of the shock detector device in response to the determination of at least one false alarm event, wherein the adjusting of the at least one detection parameter results in a decrease of a sensitivity of shock detection by the shock detector device, wherein the determination of whether the shock event is a false alarm event and/or the instructions for adjusting the at least one detection parameter are received wirelessly from at least one further device.

19. A computer-readable medium comprising instructions which, when executed by a computer, cause the computer to perform the steps of:
receiving an electrical signal;
obtaining an indication that a shock event has occurred if a value for at least one parameter of the electrical signal is determined to exceed a threshold value;
obtaining a determination of whether the shock event is a false alarm event or true alarm event; and
processing instructions for adjusting at least one detection parameter of a shock detector device in response to the determination of at least one false alarm event, wherein the adjusting of the at least one detection parameter results in a decrease of a sensitivity of shock detection by the shock detector device, wherein the determination of whether the shock event is a false alarm event and/or the instructions for adjusting the at least one detection parameter are received wirelessly from at least one further device.
